(19) United States
(12) Patent Application Publication
(10) Pub. No.: US 2018/0127901 A1
(43) Pub. Date: May 10, 2018

(54) METHOD FOR MANUFACTURING HEATING SHEET AND APPARATUS FOR MANUFACTURING SAME

(71) Applicant: DAE YU CT CO., LTD., Daejeon (KR)

(72) Inventors: Joong Hwan MO, Daejeon (KR); Myung Sook KIM, Gongju-si, Chungcheongnam-do (KR); Jin Ho CHO, Pyeongtaek-si, Gyeonggi-do (KR)

(73) Assignee: DAE YU CT CO., LTD., Daejeon (KR)

(21) Appl. No.: 15/574,157

(22) PCT Filed: May 13, 2016
(86) PCT No.: PCT/KR2016/005083

§ 371 Date: Nov. 15, 2017

(30) Foreign Application Priority Data
May 15, 2015 (KR) 10-2015-0068027

(51) Int. Cl. D03D 15/02; D06M 11/74; H05B 3/14; H05B 3/34; D03D 25/00

(52) U.S. Cl. CPC D03D 15/02; D06M 11/74; D10B 2401/16; H05B 3/347; D03D 25/005; H05B 3/145

(57) ABSTRACT

The present invention relates to a method for manufacturing a heating sheet, the method comprising the steps of: a) weaving a weft including a carbon-coated weft W1 and a normal weft W2 and a warp including a metal wire into a fabric; b) cutting the woven fabric and connecting a power supply line to an electrode lead part by using, as the electrode lead part, a portion where the metal wire is located at the end of the cut fabric; and c) shielding the entire sheet-type fabric including the fabric and the power supply line by coating the same with an outer sheath, wherein, in step a), the carbon-coated weft W1 and the normal weft W2 satisfy formula 1 below:

0.2≤d₁/d₂≤0.8 [Formula 1]

[In formula 1, d₁ is the denier of the carbon-coated weft W1 and d₂ is the denier of the normal weft W2.]

### TECHNICAL FIELD

The present invention relates to a method for manufacturing a heating sheet and an apparatus for manufacturing the heating sheet, and more particularly, to a method for manufacturing a heating sheet, which is characterized by adjusting a denier of a weft to a certain range in order to protect a heating medium, that is, a carbon-coated weft W1, and a metal wire and introducing a guide to perform a weaving process more easily, and an apparatus for manufacturing the heating sheet.

### BACKGROUND ART

A car seat on which a driver or passengers may sit so that the driver or passengers may comfortably drive or sit in a car is provided inside the car. Such a car seat may include a seat cover made of a natural material such as leather or cotton or a synthetic resin such as polyester, polyamide (nylon), and the like, and a cushion member having a cushion for comfortable seating and to protect occupants when a car accident happens. With the gradual industrial development and the ongoing growth of the automobile industry, lots of more safe, convenient and comfortable car seats have been developed and sold to enhance riding quality for drivers or passengers as well as car driving performance.

In recent years, heating sheets for cars in which a heating function is imparted to a car seat have been developed to eliminate some discomforts such as a decrease in body temperature of passengers due to a low temperature in a car in the winter when the passengers are seated in car seats, and a lot of time required to warm the inside of the car even when the car is started to run a heater in order to operate a hot-air blower.

For the heating function of a conventional car seat, a heating unit is built in the car seat in the form of a copper wire or a conductive metal wire such as silver so that the heating unit is surrounded with a cushion layer using a sponge or synthetic resin, or fabric and nonwoven fabric layers. Therefore, the heating unit is used in a state in which the heating unit is attached to an inner part of a car cover in the form of a pad. Also, a metal heat wire method is employed to sew a metal wire into certain shapes and install a temperature sensor and a heat protection device thereinside to adjust a heat generation rate. Such technology for heating mats or conductive fibers for cars is disclosed in Korean Registered Patent No. 1372543, Korean Unexamined Patent Publication No. 10-2006-0124866, and the like.

However, the problems of such prior-art documents are as follows: The metal wire may be cut due to friction with occupants or the sensor may malfunction. As a result, a decrease in durability, an increase in a heat generation rate, burns, fires, and the like may occur. Also, the metal wire or carbon-coated wire has drawbacks in that riding quality may be degraded due to the wire's inherent stiffness and it is difficult to maintain a flat surface due to degraded smoothness. Particularly, in the case of Korean Unexamined Patent Publication No. 10-2006-0124866, because the entire surface of the carbon-coated wire is coated with carbon particles, the carbon-coated wire has a drawback in that it has very low flexibility, and thus surface cutting may occur during a repeated test.

Therefore, there is a need to develop a technique to solve the above problems.

### PRIOR-ART DOCUMENTS

### Patent Documents

Korean Registered Patent No. 1372543 (Feb. 28, 2014)

Korean Unexamined Patent Publication No. 10-2006-0124866 (Dec. 6, 2006)

### DISCLOSURE

### Technical Problem

The present invention is designed to solve the problems of the prior art, and it is an object of the present invention to provide a method for manufacturing a heating sheet using a carbon-coated fiber as a weft, which is capable of inhibiting damage or disconnection of the carbon-coated fiber caused due to friction by adjusting deniers of a carbon-coated weft W1 and a normal weft W2 to certain ranges and improving surface smoothness because a polyalkylene oxide is included in a treatment solution.

It is another object of the present invention to provide an apparatus for manufacturing a heating sheet, which is capable of controlling an uneven leveling phenomenon caused when a guide is introduced during introduction of a weft to weave the weft.

### Technical Solution

To solve the above problems, according to an aspect of the present invention, there is provided a method for manufacturing a heating sheet according to the present invention, which includes a) weaving a weft including a carbon-coated weft W1 and a normal weft W2 and a warp including a metal wire into a fabric; b) cutting the woven fabric and connecting a power supply line to an electrode lead part, wherein a portion of an end of the cut fabric in which a metal wire is located is used as the electrode lead part; and c) coating the entire sheet-type fabric, which includes the fabric and the power supply line, with an outer sheath to shield the entire sheet-type fabric from the outside. Here, in step a), the carbon-coated weft W1 and the normal weft W2 satisfy the following Equation 1:

0.2≤d₁/d₂≤0.8 [Equation 1]

wherein d₁ represents a denier of the carbon-coated weft W1, and d₂ represents a denier of the normal weft W2.

In the method for manufacturing a heating sheet according to one exemplary embodiment of the present invention, the carbon-coated weft W1 may be coated with a treatment solution, which includes (1) 5 to 30% by weight of one or more carbon components selected from carbon black, furnace black, graphene, carbon nanotubes, and a carbon precursor; (2) 40 to 70% by weight of one or more base resins selected from polyvinyl alcohol, polyurethane, polyethylene, an ethylene-vinyl acetate copolymer, polyvinyl chloride, and silicon; and (3) 15 to 30% by weight of one or more additives selected from an antioxidant, a dispersing agent, a surfactant, and inorganic particles, but the present invention is not limited thereto.

In the method for manufacturing a heating sheet according to one exemplary embodiment of the present invention, the denier of the metal wire may be in a range of 1 to 200 deniers, but the present invention is not limited thereto. In this case, the metal wire may be made of one or more elements selected from silver, gold, copper, aluminum, nickel, chromium, iron, manganese, titanium, zinc, and tin, but the present invention is not limited thereto.

In the method for manufacturing a heating sheet according to one exemplary embodiment of the present invention, 0.1 to 5% by weight of a polyalkylene oxide may be further mixed with the treatment solution, but the present invention is not limited thereto.

According to another aspect of the present invention, there is provided an apparatus for manufacturing a heating sheet, which includes a weaving part (100); a warp supply part (200) provided in the rear of the weaving part (100) and including a metal wire bobbin (210) configured to supply a metal wire and a normal warp bobbin (220) configured to supply a normal warp; and a weft supply part (300) provided at one side of the weaving part (100) and including a carbon-coated weft bobbin (310), a normal weft bobbin (320), and a guide (330). In this case, the guide (330) may be installed between the carbon-coated weft bobbin (310) and the weaving part (100), and configured to supply a weft drawn from the carbon-coated weft bobbin (310) to the weaving part (100).

In the apparatus for manufacturing a heating sheet according to one exemplary embodiment of the present invention, the apparatus for manufacturing a heating sheet may further include a weft cutting part, but the present invention is not limited thereto.

In the apparatus for manufacturing a heating sheet according to one exemplary embodiment of the present invention, the guide (300) may include a guiding part (331) configured to introduce the weft drawn from the carbon-coated weft bobbin (310); a first tension control part (332) configured to pass the weft passed through the guiding part (331) between two metal plates thereof in a state in which the weft comes into contact with the two metal plates; a first guide hole (333) configured to pass the weft passed through the first tension control part (332) therethrough and inhibit vibration of the weft passing through the first tension control part (332); a second tension control part (334) configured to pass the weft passed through the first guide hole (333) between two metal plates thereof in a state in which the weft comes into contact with the two metal plates; and a second guide hole (335) configured to pass the weft passed through the second tension control part (334) therethrough to supply the weft to the weaving part (100) and inhibit vibration of the weft passing through the second tension control part (334).

In the apparatus for manufacturing a heating sheet according to one exemplary embodiment of the present invention, the guide (300) may satisfy the following Equation 2:

1.0V1≤V2≤1.1V1 [Equation 2]

wherein V1 represents a velocity of the weft immediately after the weft passes through the first tension control part (332), and V2 represents a velocity of the weft immediately after the weft passes through the second tension control part (334).

### Advantageous Effects

A method for manufacturing a heating sheet according to the present invention can be useful in preventing cutting or cracks of a carbon-coated weft W1 during a weaving process by adjusting deniers of the carbon-coated weft W1 and the normal weft W2 to certain ranges.

Also, in the method for manufacturing a heating sheet according to the present invention, because a heating sheet is manufactured by adjusting the deniers of the carbon-coated weft W1 and the normal weft W2 to certain ranges, the carbon-coated weft W1 and the normal weft W2 can be divided into two parts and surrounded by the warp, durability can be maintained even when the carbon-coated weft W1 having poor flexibility is used, and damage to the heating sheet caused by external impact can be prevented.

In addition, because the heating sheet woven according to the present invention has further improved smoothness, the heating sheet may minimize friction with a passenger's hip, and impart improved riding quality.

Additionally, because the heating sheet according to the present invention uses a fabric including a carbon fiber as a heating source, the heating sheet can reduce harmfulness to the human body caused by electromagnetic waves, and thus can be applied to heating sheets for cars, household sofas and sitting cushions, heating mats, and the like.

Further, the apparatus for manufacturing a heating sheet according to the present invention can solve a drawback of a carbon-containing coating wire, that is, insufficient flexibility, and improve smoothness of fabrics by introducing a guide configured to supply the carbon-coated weft W1.

Meanwhile, unless explicitly stated otherwise herein, it will be added that the following effects disclosed in this specification and their potential effects, all of which are expected from the technical features of the present invention, are considered to be dealt with as disclosed in the detailed description of the present invention.

### DESCRIPTION OF DRAWINGS

FIG. 1 is a perspective view of an apparatus for manufacturing a heating sheet according to one exemplary embodiment of the present invention.

FIG. 2 is an enlarged perspective view of a guide (300) as shown in FIG. 1.

FIG. 3 is a plan view showing a heating sheet manufactured according to one exemplary embodiment of the present invention, to which a power supply part (410) is not connected.

FIG. 4 is a plan view showing a heating sheet (400) manufactured according to one exemplary embodiment of the present invention.

FIG. 5 is a cross-sectional view showing a lateral section of the heating sheet (400) as shown in FIG. 4 after the heating sheet 400 is cut along line I-I′.

### BEST MODE

Hereinafter, the present invention will be described in further detail with reference to the accompanying drawings and embodiments thereof. However, it should be understood that the following embodiments and examples are merely representative for purposes of describing the present invention in detail, and various modifications and changes can be made to the embodiments and examples without departing from the scope of the present invention

Unless otherwise defined in this specification, all the technical and scientific terms used herein have the same meanings as what are generally understood by a person skilled in the related art to which the present invention belongs. Therefore, the terms used in the detailed description are merely used for the purpose of describing particular embodiments, but are not intended to limit the present invention.

Also, the drawings presented herein are provided as examples for sufficiently imparting the spirit and scope of the present invention to persons having ordinary skill in the art. Therefore, it will be apparent that the present invention can be embodied in various forms without being limited to the accompanying drawings, and the drawings presented herein may be shown in an exaggerated way to describe the scope of the present invention more clearly. Also, in the drawings, like numbers refer to like elements throughout this specification.

As used in this specification and the appended claims provided herein, the singular forms “a,” “an” and “the” are intended to include the plural forms as well, unless the context clearly indicates otherwise.

Also, it should be understood that, although the terms “first,” “second,” “A,” “B,” “(a),” “(b),” etc. may be used herein to describe various elements of the present invention, the nature, order or sequence of these elements should not be limited by these terms. These terms are used only to distinguish one element from another. In addition, it will be understood that when an element is referred to as being “connected” or “coupled” to another element throughout the specification, it can be directly connected or coupled to the other element or intervening elements may be present.

The present inventors have conducted ardent research to solve problems regarding the general use of a carbon fiber wire in conventional sheet-type heating units such as damage or disconnection of the carbon fiber wire caused by external friction, and developed a sheet-type heating sheet capable of making a difference in denier between a carbon-coated weft W1 and a normal weft W2 to inhibit external exposure of the carbon-coated weft W1 to the maximum extent and protect the carbon-coated weft W1 from external impact, and simultaneously adjusting a heat generation rate and persistently maintaining heating characteristics when a metal wire is used as a warp to perform a weaving process. Therefore, the above problems may be solved based on these facts.

A method for manufacturing a heating sheet according to the present invention includes a) weaving a weft including a carbon-coated weft W1 and a normal weft W2 and a warp including a metal wire into a fabric; b) cutting the woven fabric and connecting a power supply line to an electrode lead part, a portion of the cut fabric having a metal wire located at an end thereof being used as the electrode lead part; and c) coating the entire sheet-type fabric, which includes the fabric and the power supply line, with an outer sheath to shield the entire sheet-type fabric from the outside.

The carbon-coated weft W1 according to one exemplary embodiment of the present invention is preferably coated with a treatment solution, which includes (1) 5 to 30% by weight of one or more carbon components selected from carbon black, furnace black, graphene, carbon nanotubes, and a carbon precursor; (2) 40 to 70% by weight of one or more base resins selected from polyvinyl alcohol, polyurethane, polyethylene, an ethylene-vinyl acetate copolymer, polyvinyl chloride, and silicon; and (3) 15 to 30% by weight of one or more additives selected from an antioxidant, a dispersing agent, a surfactant, and inorganic particles, but the present invention is not limited thereto.

In the present invention, types of the carbon components are not limited as long as they are used for coating in the related art to prepare a conductive fiber. Examples of the carbon components that may be used may include one or more carbon components selected from carbon black, furnace black, graphene, carbon nanotubes, and a carbon precursor.

In the present invention, a particle size of the carbon component is not limited as long as the particle size of the carbon component falls within a range which does not hinder an object of the present invention. For example, it is desirable that the carbon component has a particle size of 0.0001 to 0.01 μm because the carbon component can be readily woven and detachment of particles does not occur.

In addition to the carbon component, an inorganic conductive filler may also be further introduced to reduce a resistance value. The content of the inorganic conductive filler is not particularly limited as long as the content of the inorganic conductive filler falls within a range which does not hinder an object of the present invention. In this case, conductive particles generally used in the related art may be used as the inorganic conductive filler.

Examples of the inorganic conductive filler may, for example, include metal particles including gold, silver, nickel, copper, and the like, particles plated or coated with the metal component, or a conductive filler obtained by further coating surfaces of the particles with the carbon component of the present invention. Specific examples of the inorganic conductive filler may include magnesium oxide, silicon carbide, and the like, which may be used alone or in combination of two or more.

An amount of the conductive filler added is not limited as long as the amount of the conductive filler falls within a range which does not hinder an object of the present invention. Preferably, 1 to 50% by weight of 100% by weight of the carbon component is replaced with the conductive filler and used.

In the present invention, the carbon component may be added at a content of 5 to 30% by weight, based on the total weight of the treatment solution. When the carbon component is added at a content of less than 5% by weight, desired conductivity may not be sufficiently exhibited in the present invention. On the other hand, when the carbon component is added at a content of greater than 30% by weight, flexibility of the carbon-coated weft W1 may be degraded, resulting in manufactured fabrics having poor texture.

In the present invention, the base resin serves as an adhesive used to coat a fiber with the carbon component and an additive. In this case, types of the base resin are not limited as long as the base resin is a material which does not cause a secondary reaction with the fiber. Examples of the base resin may include polyvinyl alcohol, polyurethane, polyethylene, an ethylene-vinyl acetate copolymer, polyvinyl chloride, and silicon, which may be used alone or in combination of two or more.

Specifically, even when the base resins are of the same type, the base resins may have different weight average molecular weights (Mw), when necessary. Even when two or more base resins are included, the respective resins may have the same weight average molecular weight according to a purpose.

In the present invention, the base resin may be included at a content of 40 to 70% by weight, based on the total weight of the treatment solution composition. When the base resin is added at a content of less than 40% by weight, the weft may not be properly coated with the carbon component due to a very low content of the base resin. On the other hand, when the base resin is added at a content of greater than 70% by weight, the weft may not satisfy a range of Equation 1 because the base resin has an influence on the denier of the weft after coating.

In the present invention, the additive is generally used in the related art. In this case, types of the additive are not limited as long as they do not reduce conductivity. Examples of the additive may, for example, include one or more selected from an antioxidant, a dispersing agent, a surfactant, and inorganic particles.

In the present invention, both primary and secondary antioxidants may be used as the antioxidant. Preferably, phenols (sulfur-containing phenol, bisphenol, polyphenol, and the like), aromatic amines, phosphites, sulfur esters, and the like may be used. More preferably, butylated hydroxy toluene, tris(nonylphenyl)phosphite, and the like may be used.

In the present invention, the dispersing agent is generally a material represented by waxes. In this case, types of the dispersing agent are not limited as long as the dispersing agent is generally used in the related art to disperse inorganic and organic particles. Examples of the dispersing agent may, for example, include amide-based wax, polyolefin-based wax, and the like, which may be used alone or in combination thereof.

In the present invention, the surfactant is adsorbed onto the interface in a coating composition, and thus serves to reduce the surface tension of the coating composition. In particular, inorganic particles such as silica used as an absorption filler are easily dispersed in a resin due to degraded interfacial adhesion between the inorganic particles and the resin. Also, the surfactant serves to enhance solubility of the additive dissolved in the composition. Examples of the surfactant may, for example, include a polyoxyethylene stearyl ester derivative, a sorbitan fatty acid ester derivative, a polyoxyethylene oleylamine derivative, sodium stearate, and the like, which may be used alone or in combination of two or more.

In the present invention, types of the inorganic particles may be added without limitation as long as the inorganic particles are generally used in the related art. For example, materials that are the same or different from the inorganic conductive filler may also be used.

In the present invention, the additive may be included in the composition at a content of 15 to 30% by weight. When the additive includes two or more components, the sum of weights of the respective components should satisfy this content range, but the present invention is not limited thereto. For example, the content of the additive may be readily adjusted in a range which may achieve an object of the present invention.

Also, in the method for manufacturing a heating sheet according to one exemplary embodiment of the present invention, the additive may further include a polyalkylene oxide to improve surface smoothness in the carbon-coated fiber, maximize a spreading property and frictional resistance, and prevent detachment of carbon particles. In the present invention, the term “spreading property” refers to a property of spreading a bundle of carbon-coated fibers.

In the present invention, the polyalkylene oxide may have a structure represented by the following Formula 1.

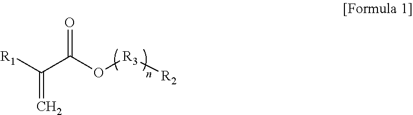

wherein R₁ or R₂ is hydrogen, a C1-C30 alkyl group, a C3-C10 cycloalkyl group, or a C6-C10 aryl group;

R₃ is ethylene oxide, propylene oxide, or an ethylene-propylene block; and

n is an integer ranging from 1 to 100.

In the present invention, each alkylene oxide group constituting the polyalkylene oxide chain may be represented by either -AO- or -OA- when it is assumed that an alkylene group is ‘A.’ The alkylene group may be represented by ethylene, propylene, an ethylene-propylene block, and the like, and may preferably have 2 to 6 carbon atoms. Also, the alkylene oxides may be used in combination of two or more.

The integer ‘n’ represents a repeat number of alkylene oxide groups, and is preferably in a range of 1 to 100, more preferably in a range of 2 to 35.

In the present invention, the polyalkylene oxide may be further included instead of one component of the treatment solution. In this case, the polyalkylene oxide may be included at a content of 0.1 to 5% by weight, based on the total weight of the treatment solution. When the polyalkylene oxide is added at a content of less than 0.1% by weight, desired smoothness may not be exhibited in the present invention. On the other hand, when the polyalkylene oxide is added at a content of greater than 5% by weight, phase separation between the additive and the other components may occur, which makes it impossible to form the coating layer itself.

In the present invention, the carbon-coated weft is dipped in the treatment solution and dried so that the carbon-coated weft is coated with the treatment solution. In this case, the dipping process may be performed one or more times.

In the present invention, the wefts may be divided into a carbon-coated weft W1 and a normal weft W2. However, the carbon-coated weft and the normal weft are divided depending on whether the wefts are coated with the carbon component, but not divided depending on the fiber's own components or other physical properties.

In the present invention, the carbon-coated weft or the normal weft is not limited by the components and denier of the fiber, and the like. For example, the carbon-coated weft and the normal weft may have the same or different physical properties, but the present invention is not limited thereto.

In the present invention, the carbon-coated weft or normal weft is a general fiber used for weaving in the related art. For example, examples of the carbon-coated weft or normal weft may include synthetic resins, that is, homopolymers or copolymers of α-olefins such as ethylene, propylene, 1-butene, 1-hexene, 4-methyl-1-pentene and 1-octene, such as high-pressure, low-density polyethylene, linear low-density polyethylene (i.e., LLDPE), high-density polyethylene (i.e., HDPE), polypropylene (a propylene homopolymer), polyolefins such as a polypropylene random copolymer, poly(l-butene), poly(4-methyl-1-pentene), an ethylene-propylene random copolymer, an ethylene-butene random copolymer, a propylene-butene random copolymer, and the like, polyesters (polyethylene terephthalate, polybutylene terephthalate, polyethylene naphthalate, and the like), polyamides (nylon-6, nylon-66, poly(meta-xylene adipamide), and the like), polyvinyl chloride, polyimide, ethylene vinyl acetate copolymers, ethylene vinyl acetate alcohol copolymers, ethylene-(meth)acrylic acid copolymers, ethylene-ester acrylate-carbon monoxide copolymers, polyacrylonitrile, polycarbonate, polystyrene, ionomers, or mixtures thereof. Also, the components may be used alone or in combination of two or more. In this case, when the components are used in combination of two or more, the respective components may be used after the components are spun at the same time, or the respective spin fibers are braided, but the present invention is not limited thereto.

In the present invention, the carbon-coated weft W1 and the normal weft W2 preferably satisfy the following Equation 1 to prevent damage or disconnection of the carbon-coated weft W1 from external friction or an external force, and the like.

0.2≤d₁/d₂≤0.8 [Equation 1]

wherein d₁ represents a denier of the carbon-coated weft W1, and d₂ represents a denier of the normal weft W2.

Specifically, the heating sheet manufactured to satisfy Equation 1 may be divided into two parts to be woven based on the aforementioned warp. That is, as the carbon-coated weft W1 and the normal weft W2 are divided into two parts, the warp is further wound around a surface of the normal weft W2 having a relatively high denier. Therefore, because the warp or the normal weft W2 absorbs tension, stress, and the like which act on fabrics during a weaving process, disconnection of the carbon-coated weft W1 having poor flexibility may be prevented, and heating sheets using the carbon-coated weft W1 may be manufactured more quickly.

The warp may be the same or higher than the normal weft W2, but the present invention is not particularly limited thereto. Therefore, the warp may surround the carbon-coated weft W1 and the normal weft W2, and protect the carbon-coated weft W1 from external impact.

Also, in the present invention, when d₁/d₂ in Equation 1 is less than 0.2, the carbon-coated weft may be cut during weaving due to a very low denier of the carbon-coated weft. On the other hand, when d₁/d₂ is greater than 0.8, the carbon-coated weft is exposed to the outside together with the normal weft, which makes it difficult to avoid damage or disconnection of the carbon-coated weft caused by friction.

In the present invention, types of the warp are not limited as long as the warp is a fiber used for weaving in the related art. In this case, the warp may be the same or different from the weft. In the present invention, the denier of the warp may be in a range of 1 to 200 deniers (d), but the present invention is not limited thereto.

Types of the metal wire may be used without limitation as long as the metal wire can be used in the heating sheet and woven. The metal wire may include silver, gold, copper, aluminum, nickel, chromium, iron, manganese, titanium, zinc, and tin as main components. For the metal wire, the components may be used alone or used as an alloy thereof.

In the present invention, the weaving of step a) may be performed to include the carbon-coated weft W1 and the normal weft in a weft direction and include the normal warp including a metal wire in a warp direction. Also, after the weft and the warp were woven, the metal wire may be attached in a warp direction by adhesion or sewing.

In this case, when a polar wire is included in a warp direction by the adhesion or sewing, step a) may further include covering a top portion of the polar wire with an additional fabric or polymer film and compressing the polar wire to promote contact of the carbon fiber with the polar wire.

In the present invention, the fabric is not limited to a woven shape. Plain, twill, sateen, and rib weaves may be applied according to the purpose of use.

The woven fabric in step a) is cut to a predetermined width so that an electrode lead part may be disposed spaced apart a predetermined distance from both ends of the woven fabric. In this case, a cutting direction may be the warp and weft directions, and the woven fabric may be cut to a size corresponding to a desired shape to obtain a sheet-type sheet in the form of a sheet.

The cut sheet may be configured to connect a power supply line to an electrode lead part, wherein a portion of an end of the fabric in which a metal wire is located is used as the electrode lead part, as described in step b). The carbon-coated weft has its own characteristic of preventing overheating because the temperature does not increase any more when the temperature reaches a predetermined temperature. To regulate the temperature more effectively, the power supply line may be connected to the electrode lead part by soldering, and a temperature sensor, a temperature sensor power supply line and a thermostat may be further provided therein to regulate a heating temperature of a product.

The polar wire and thermostat may be connected through step b) to manufacture a sheet-type fabric, and the entire sheet-type fabric may be coated with an outer sheath such as artificial or natural leather to shield the sheet-type fabric from the outside, thereby manufacturing a heating sheet. The product thus manufactured may be applied to sheet-type products such as car seats, chairs, sofas, blanket, sitting cushions, or linoleum because the product is manufactured in a piece type.

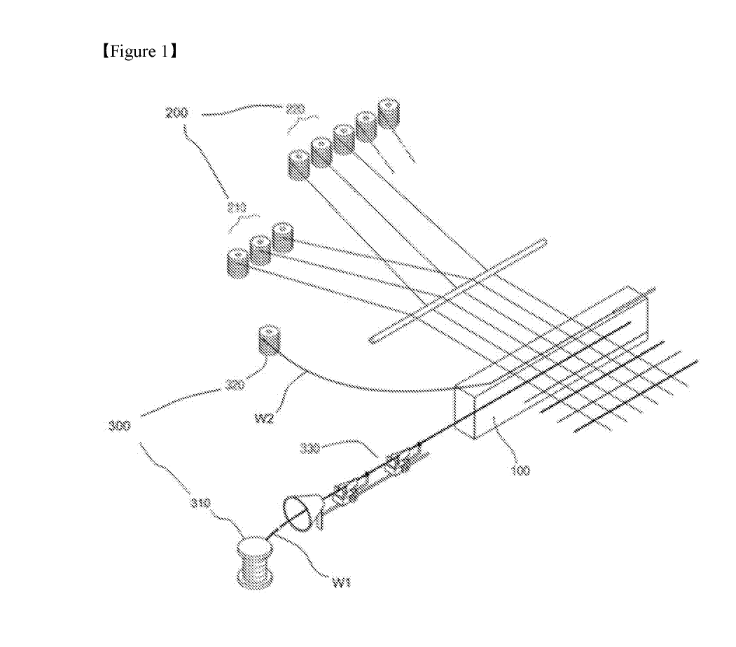

Next, the apparatus for manufacturing a heating sheet will be described in further detail with reference to the accompanying drawings. First, FIG. 1 is a diagram schematically showing a preferred embodiment of an apparatus capable of manufacturing a heating sheet according to the present invention. Here, the apparatus for manufacturing a heating sheet includes a weaving part 100 provided at the center thereof in a transverse direction, a warp supply part 200 provided in the rear of the weaving part 100 and including a plurality of metal wire bobbins 210 and normal warp bobbins 220, and a weft supply part 300 provided at one side of the weaving part 100 and including a carbon-coated weft bobbin 310, a normal weft bobbin 320, and a guide 330.

In the present invention, the warp supply part 200 may include a metal wire bobbin 210 provided in the form of plural bobbins in the rear of the weaving part to supply a metal wire, and a normal warp bobbin 220 provided in the form of plural bobbins to supply a normal warp.

Of course, the warp supply part may include only a normal warp supply part as described above, and then a method of attaching a metal wire after weaving may also be used.

In the present invention, the weft supply part 300 may include a carbon-coated weft bobbin 310 and a normal weft bobbin 320, and may also include a guide 330 provided between the carbon-coated weft bobbin 310 and the weaving part to easily supply the weft drawn from the carbon-coated weft bobbin 310 to the weaving part.

The guide 330 of the present invention in a direction of progress of the carbon-coated weft W1 will be described with reference to FIG. 2.

The guide 330 according to the present invention may include a guiding part 331 configured to introduce the weft drawn from the carbon-coated weft bobbin 310, a first tension control part 332 configured to pass the weft passed through the guiding part 331 between two metal plates thereof in a state in which the weft comes into contact with the two metal plates, a first guide hole 333 configured to pass the weft passed through the first tension control part 332 therethrough and inhibit vibration of the weft passing through the first tension control part 332, a second tension control part 334 configured to pass the weft passed through the first guide hole 333 between two metal plates thereof in a state in which the weft comes into contact with the two metal plates, and a second guide hole 335 configured to pass the weft passed through the second tension control part 334 therethrough to supply the weft to the weaving part 100 and inhibit vibration of the weft passing through the second tension control part 334.

In the present invention, the guiding part 331 is located at an inlet part of the guide to pass the carbon-coated weft W1 through the guide, and may be provided in a funnel shape, the present invention is not limited thereto.

In the present invention, the first tension control part 332 and the second tension control part 334 are each independently composed of two metal plates, and the carbon-coated weft W1 may come into contact with the metal plates. This is done to compensate for a decrease in a weaving property of the carbon-coated weft W1 due to insufficient flexibility. In this case, a twisting property and flexibility of the carbon-coated weft W1 may be enhanced at the same time by holding the weft with the metal plates.

In the present invention, the first guide hole 333 and the second guide hole 335 are provided as holes configured to pass the weft passed through the first or second tension control part therethrough. When the carbon-coated weft W1 passes through the guide holes, excessive vibration of the carbon-coated weft W1 that may be caused by the metal plates provided in the tension control part may be inhibited. Therefore, the tension of the carbon-coated weft W1 may be maintained at a predetermined level. At the same time, disconnection or cracks of the carbon-coated weft W1 caused during a weaving process may be prevented, and flexibility of the heating sheet may be provided.

In the present invention, the guide 330 including the first tension control part 332 and the second tension control part 334 may satisfy the following Equation 2:

1.0V1≤V2≤1.1V1 [Equation 2]

wherein V1 represents a velocity of the weft immediately after the weft passes through the first tension control part 332, and V2 represents a velocity of the weft immediately after the weft passes through the second tension control part 334.

Equation 2 shows the physical properties by which a twisting property and flexibility of the carbon-coated weft W1 are enhanced according to introduction of the guide 330. In this case, a passing velocity of the carbon-coated weft W1 may be determined by regulating a weft contact pressure of the metal plates provided in the first tension control part 332 and the second tension control part 334.

In the present invention, when the V2 is less than 1.0 V1, the tension of the carbon-coated weft W1 may be very low, which makes it difficult to perform a smooth weaving process. On the other hand, when the V2 is greater than 1.1 V1, the carbon-coated weft W1 may be cut while passing through the guide.

In the present invention, the carbon-coated weft W1 passing through the guide 330 is transferred to the aforementioned weaving part 100 by means of a transfer system, and subjected to a weaving process. Types of the transfer system are not limited as long as the transfer system is generally used in the related art. For example, means such as a carrier, a gripper, a needle, an air jet, a water jet, and the like may be used herein.

In the present invention, the weft including the carbon-coated weft W1 and the normal weft W2 may be cut so that the electrode lead part is located at an end of a woven product after weaving. In this case, the weft may be cut and finished by the weft cutting part. When necessary, the weft cutting part may be heated to promote a cutting process.

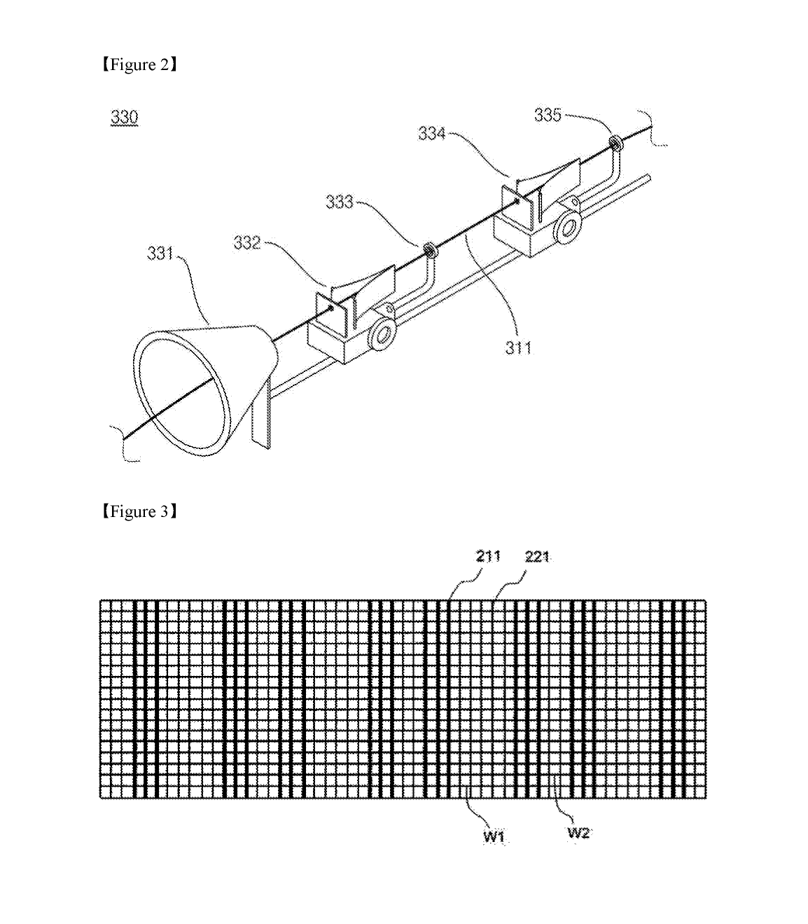

FIGS. 3 to 5 are detailed diagrams showing the heating sheet manufactured using the apparatus for manufacturing a heating sheet as shown in FIG. 1.

Specifically, FIG. 3 is a plan view showing a heating sheet 400 woven in a plain shape in a state in which a power supply part is not connected to the heating sheet 400. Here, a metal wire 211 and a normal warp 221 constitute a warp, and a carbon-coated weft W1 and a normal weft W2 constitute a weft so that the warp and the weft form a fabric.

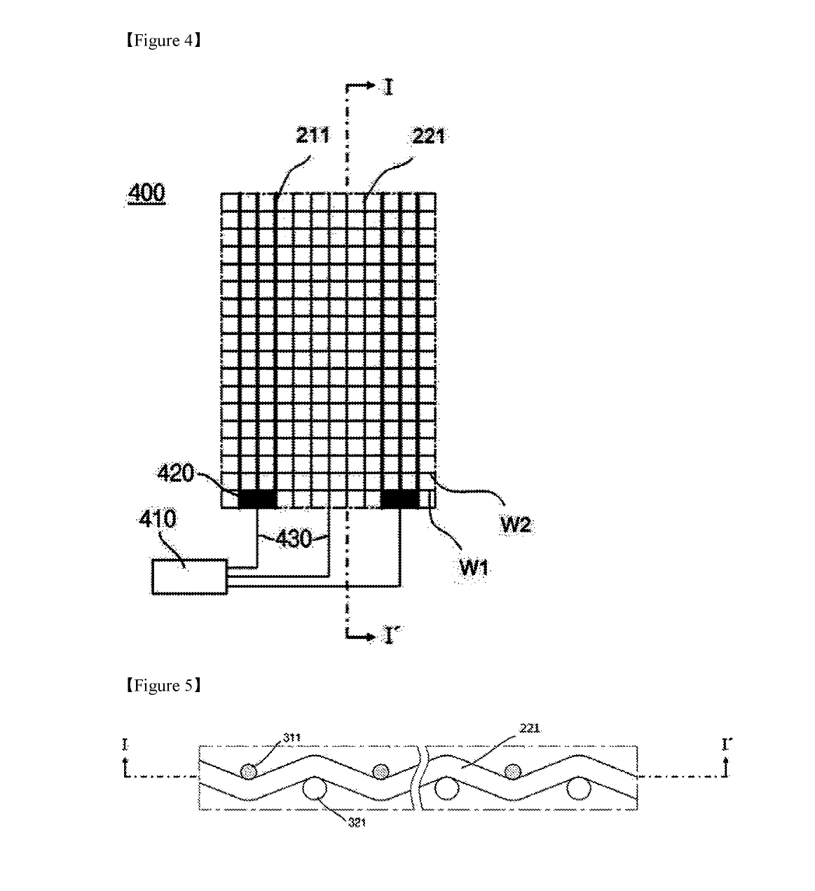

FIG. 4 is another plan view showing a heating sheet 401 in which a power supply part 410 is connected to the heating sheet 400 as shown in FIG. 3. Here, the power supply part 410 may supply power to an electrode lead part 420 through a power supply line 430. In this case, types of the electrode lead part 420 are not limited as long as the electrode lead part 420 is generally used in the related art like the soldering.

FIG. 5 is a cross-sectional view showing a lateral section of the heating sheet as shown in FIG. 4 after the heating sheet is cut along line I-I′. Here, the carbon-coated weft W1 and the normal weft W2 may be divided into two parts based on a warp such as a metal wire 211 or a normal warp 222. Therefore, when Equation 1 is satisfied, the warp is further wound around a surface of the normal weft W2, and the carbon-coated weft W1 is not exposed at a surface of the fabric due to the normal weft. The heating sheet manufactured according to the present invention has an advantage in that damage or disconnection of the carbon-coated weft W1 caused by friction may be inhibited by minimizing exposure of the carbon-coated weft W1 at the surface of the fabric, thereby significantly lengthening a lifespan of products.

### MODE FOR INVENTION

Hereinafter, the method for manufacturing a heating sheet according to the present invention will be described in further detail with reference to examples and comparative examples thereof. However, it should be understood that these examples and comparative examples are merely provided to describe the present invention in further detail, and are not intended to limit the scope of the present invention.

Physical properties of specimens manufactured in Examples and Comparative Example were measured, as follows.

(Heating Characteristics)

A 500 nm-thick FTO transparent conductive film was formed on K-type heat-resistant glass with a potentiostat (alternating current), and a silver (Ag) electrode and an electrically insulating protective film were formed on the FTO transparent conductive film. Therefore, a temperature of the conductive film was measured using a field-emission scanning electron microscope (FE-SEM).

### Example 1

First, a treatment solution was prepared with the following composition in order to prepare a carbon-coated weft. 20% by weight of carbon black (KETJEN BLACK-EC600DJ, Lion Akzo Co., Ltd.), 60% by weight of polyurethane (KPU-300, Kukdo Chemical Co., Ltd.), and 20% by weight of an additive, which was prepared by mixing an antioxidant (butylated hydroxy toluene), a dispersing agent (amide-based wax) and a surfactant (sodium stearate) at a weight ratio of 1:1:1, were put into an agitator, and mixed to prepare a treatment solution. A polyethylene terephthalate (PET, denier: 30 d) fiber was dipped in the finished treatment solution, and then dried to manufacture a carbon-coated weft.

Next, a PET fiber having a denier of 60 d and the carbon-coated weft were supplied as the normal wefts into a weaving machine, and the normal warp (PET, denier: 60 d) and a metal wire (copper, denier: 60 d) were supplied as the warps into the weaving machine, and a weaving process was then performed. The woven specimen was subjected to wear rotation based on a rotary platform of ASTM D3884 (a wear resistance test on fabrics). Then, an electric power supply line was connected to the metal wire, and a temperature sensor and a thermostat were connected thereto to finish a specimen. An electric current was applied to the finished specimen for 10 minutes, and heating characteristics according to a voltage were measured.

### Example 2

A specimen was finished in the same manner as in Example 1, except that 3% by weight of polyethylene oxide having a weight average molecular weight of 3,000 was further added to the treatment solution instead of the polyurethane. An electric current was applied to the finished specimen, and heating characteristics according to a voltage were measured.

### Comparative Example 1

A specimen was finished in the same manner as in Example 1, except that the carbon-coated weft was prepared using a PET fiber having a denier of 60 d. An electric current was applied to the finished specimen, and heating characteristics according to a change in voltage were measured.

TABLE 1

| | Number of | | | Temper- | |
|---|---|---|---|---|---|
| | times of | Voltage | Current | ature | |
| | rubbing | (V) | (mA) | (° C.) | Notes |
| Example 1 | 1,000 | 20 | 36.5 | 65 | |
| | 2,500 | | 34.7 | 63 | |
| | 5,000 | | 31.3 | 58 | |
| Example 2 | 1,000 | 20 | 36.6 | 65 | |
| | 2,500 | | 35.3 | 63 | |
| | 5,000 | | 35.0 | 62 | |
| Comparative | 1,000 | 20 | 27.2 | 54 | |
| Example 1 | 2,500 | | 14.0 | 20 | |
| | 5,000 | | — | — | Disconnected |

As listed in Table 1, the heating sheet manufactured according to the present invention has a sufficient heating temperature because the disconnection of the carbon-coated weft was inhibited as the number of times of rubbing increased compared to Comparative Example. In particular, it can be seen that, in the case of Example 2 in which the polyethylene oxide was further added to the treatment solution, the flexibility of the carbon-coated weft was further enhanced to improve smoothness of the sheet, and thus the disconnection of the carbon-coated weft was further inhibited.

Although the present invention has been described above in detail with reference to certain examples and embodiments thereof and the accompanying drawings, it will be understood by those skilled in the art that various changes and modifications can be made to the detailed description and specific examples of the present invention without departing from the spirit and scope of the invention as defined by the appended claims.

Thus, it should be understood that the scope of the present invention is defined not by the detailed description, but by the appended claims and their equivalents. Therefore, it is intended that the present invention covers all such modifications provided they come within the scope of the appended claims and their equivalents.

### DESCRIPTION OF PARTS

100: weaving part
200: warp supply part, 210: metal wire bobbin, 211: metal wire, 220: normal warp bobbin, 221: normal warp
300: weft supply part, 310: carbon-coated weft bobbin, W1: carbon-coated weft, 320: normal weft bobbin, W2: normal weft, 330: guide, 331: guiding part, 332: first tension control part, 333: first guide hole, 334: second tension control part, 335: second guide hole
400: heating sheet, 410: power supply part, 420: electrode lead part, 430: power supply line

1. A method for manufacturing a heating sheet, comprising:
a) weaving a weft including a carbon-coated weft W1 and a normal weft W2 and a warp including a metal wire into a fabric;
b) cutting the woven fabric and connecting a power supply line to an electrode lead part, wherein a portion of an end of the cut fabric in which a metal wire is located is used as the electrode lead part; and
c) coating the entire sheet-type fabric, which includes the fabric and the power supply line, with an outer sheath to shield the entire sheet-type fabric from the outside,
wherein, in step a), the carbon-coated weft W1 and the normal weft W2 satisfy the following Equation 1:
0.2≤d₁/d₂≤0.8 [Equation 1]
wherein d₁ represents a denier of the carbon-coated weft W1, and d₂ represents a denier of the normal weft W2.

2. The method of claim 1, wherein the carbon-coated weft W1 is coated with a treatment solution comprising:
(1) 5 to 30% by weight of one or more carbon components selected from carbon black, furnace black, graphene, carbon nanotubes, and a carbon precursor;
(2) 40 to 70% by weight of one or more base resins selected from polyvinyl alcohol, polyurethane, polyethylene, an ethylene-vinyl acetate copolymer, polyvinyl chloride, and silicon; and
(3) 15 to 30% by weight of one or more additives selected from an antioxidant, a dispersing agent, a surfactant, and inorganic particles.

3. The method of claim 1, wherein the denier of the metal wire is in a range of 1 to 200 deniers, and the metal wire is made of one or more elements selected from silver, gold, copper, aluminum, nickel, chromium, iron, manganese, titanium, zinc, and tin.

4. The method of claim 2, wherein 0.1 to 5% by weight of a polyalkylene oxide is further mixed with the treatment solution.

5. An apparatus for manufacturing a heating sheet, comprising:
a weaving part (100);
a warp supply part (200) provided in the rear of the weaving part (100) and comprising a metal wire bobbin (210) configured to supply a metal wire and a normal warp bobbin (220) configured to supply a normal warp; and
a weft supply part (300) provided at one side of the weaving part (100) and comprising a carbon-coated weft bobbin (310), a normal weft bobbin (320), and a guide (330),
wherein the guide (330) is installed between the carbon-coated weft bobbin (310) and the weaving part (100), and configured to supply a weft drawn from the carbon-coated weft bobbin (310) to the weaving part (100).

6. The apparatus of claim 5, wherein the apparatus for manufacturing a heating sheet further comprises a weft cutting part.

7. The apparatus of claim 5, wherein the guide (300) comprises:
a guiding part (331) configured to introduce the weft drawn from the carbon-coated weft bobbin (310);
a first tension control part (332) configured to pass the weft passed through the guiding part (331) between two metal plates thereof in a state in which the weft comes into contact with the two metal plates;
a first guide hole (333) configured to pass the weft passed through the first tension control part (332) therethrough and inhibit vibration of the weft passing through the first tension control part (332);
a second tension control part (334) configured to pass the weft passed through the first guide hole (333) between two metal plates thereof in a state in which the weft comes into contact with the two metal plates; and
a second guide hole (335) configured to pass the weft passed through the second tension control part (334) therethrough to supply the weft to the weaving part (100) and inhibit vibration of the weft passing through the second tension control part (334).

8. The apparatus of claim 5, wherein the guide (300) satisfies the following Equation 2:
1.0V1≤V2≤1.1V1 [Equation 2]
wherein V1 represents a velocity of the weft immediately after the weft passes through the first tension control part (332), and V2 represents a velocity of the weft immediately after the weft passes through the second tension control part (334).
